(19) United States
(12) Patent Application Publication
(10) Pub. No.: US 2014/0123754 A1
(43) Pub. Date: May 8, 2014

(54) PHYSICAL QUANTITY DETECTING DEVICE, ELECTRONIC APPARATUS, AND MOVING OBJECT

(71) Applicant: Seiko Epson Corporation, Tokyo (JP)

(72) Inventors: Jun Watanabe, Matsumoto (JP); Kazuyuki Nakasendo, Shiojiri (JP)

(73) Assignee: Seiko Epson Corporation, Tokyo (JP)

(21) Appl. No.: 14/068,486

(22) Filed: Oct. 31, 2013

(30) Foreign Application Priority Data
Nov. 7, 2012 (JP) 2012-245101

(51) Int. Cl. G01P 15/02

(52) U.S. Cl. CPC G01P 15/02
USPC 73/514.01

(57) ABSTRACT

A physical quantity detecting device includes a metal block (a holding section) having six surfaces, inclination detectors (physical quantity detectors) respectively arranged on selected three surfaces among the six surfaces, an electronic component electrically connected to the inclination detectors, and a heat insulating material (a heat-conduction reducing section) present between the metal block and the electronic component and having thermal conductivity smaller than the thermal conductivity of the metal block.

### BACKGROUND

1. Technical Field

The present invention relates to a physical quantity detecting device for detecting a physical quantity and an electronic apparatus and a moving object mounted with the physical quantity detecting device.

2. Related Art

Configuration examples of a physical quantity detecting device in the past include an acceleration sensor described in JP-A-2002-277484 (Patent Literature 1). In the acceleration sensor, an acceleration detecting element and an electronic circuit (an electronic component) are mounted on a ceramic substrate and a ceramic cover is bonded to the ceramic substrate to hermetically seal the acceleration detecting element and the electronic circuit. A wire from the electronic circuit is led out to the outside by a conductor pattern. With such an acceleration sensor, it is possible to surface-mount the acceleration sensor on a substrate. It is possible to set a detected acceleration direction parallel to the surface of the substrate to which the acceleration is attached. Therefore, it is possible to easily apply the acceleration sensor to a use such as an airbag illustrated in the Patent Literature 1.

In a detecting element such as the acceleration detecting element, when the temperature of the entire device is not uniform, detection accuracy of a physical quantity tends to be unstable. It is desirable to suppress a temperature change as much as possible. In this regard, in the related art, since the detecting element is arranged near the electronic circuit, the detecting element is easily affected by heat due to heat generation of the electronic circuit.

### SUMMARY

An advantage of some aspects of the invention is to solve at least a part of the problems described above, and the invention can be implemented as the following forms or application examples.

### Application Example 1

A physical quantity detecting device according to this application example includes: a physical quantity detector; a holding section holding the physical quantity detector; an electronic component electrically connected to the physical quantity detector; and a heat-conduction reducing section arranged between the holding section and the electronic component and having thermal conductivity smaller than the thermal conductivity of the holding section.

In the physical quantity detecting device according to this application example, the physical quantity detector capable of detecting the tilt, the acceleration, and the like of the holding section and the heat-conduction reducing section are arranged in the holding section. The thermal conductivity of the heat-conduction reducing section is set smaller than the thermal conductivity of the holding section. The physical quantity detecting device includes the heat-conduction reducing section between the holding section and the electronic component such that heat generated from the electronic component is insulated by the heat-conduction reducing section and hardly transferred in the direction of the holding section. Consequently, in the physical quantity detecting device, the influence of the heat from the electronic component on the physical quantity detector is generally suppressed. It is possible to maintain excellent detection accuracy.

### Application Example 2

In the physical quantity detecting device according to the application example described above, it is preferable that, on a surface on which the holding section and the heat-conduction reducing section are connected, the surface roughness Ra of at least one of the holding section and the heat-conduction reducing section is equal to or larger than 0.5 μm. In the physical quantity detecting device according to the application example described above, it is preferable that, the holding section includes a plurality of surfaces, the heat-conduction reducing section is connected to at least one of the plurality of surfaces, and the physical quantity detecting device includes, on a connection surface of the holding section and the heat-conduction reducing section, a portion where the holding section and the heat-conduction reducing section are connected to each other and an air gap portion where the holding section and the heat-conduction reducing section are not connected to each other.

On the surface on which the holding section and the heat-conduction reducing section are connected, since the holding section and the heat-conduction reducing section are not in an entirely adhering state and the surface of the holding section or the heat-conduction reducing section is rough, gaps are formed. It has been known that, if the gaps are gaps formed when the surface roughness Ra of the holding section or the heat-conduction reducing section is equal to or larger than 0.5 μm, there is an effect that heat transfer from the heat-conduction reducing section to the holding section is suppressed. Consequently, the physical quantity detecting device can suppress the influence of the heat on the physical quantity detector from the electronic component using a simple method of managing the surface roughness Ra.

### Application Example 3

In the physical quantity detecting device according to the application example described above, it is preferable that the holding section includes a plurality of surfaces, the heat-conduction reducing section is connected to at least one of the plurality of surfaces, and, in the holing section, the surface roughness of a surface on which the heat-conduction reducing section is arranged is larger than the surface roughness of a surface on which the physical quantity detector is arranged.

With this configuration, in the holding section, the surface roughness Ra of the surface on which the heat-conduction reducing section is arranged is larger than the surface roughness Ra of the surface on which the physical quantity detector is arranged. Therefore, there is an effect that heat transfer from the heat-conduction reducing section to the holding section is insulated. On the surface of the holding section on which the physical quantity detector is arranged, it is hardly necessary to take into account heat transfer to the physical quantity detector because of the heat insulation on the heat-conduction reducing section and the holding section surface on which the heat-conduction reducing section is arranged. Therefore, the physical quantity detector can be stably mounted with the surface roughness Ra set small. In this way, in the holding section, each of the surface connected to the physical quantity detector and the surface to which the heat-conduction reducing section is connected has optimum surface roughness Ra. Therefore, it is possible to suppress the influence of heat on the physical quantity detector from the heat-conduction reducing section.

### Application Example 4

In the physical quantity detecting device according to the application example described above, it is preferable that the physical quantity detecting device has an air gap between the holding section and the heat-conduction reducing section.

With this configuration, the air gap includes an air layer having high heat insulation properties and plays a role of effectively insulating, in a boundary section between the heat-conduction reducing section and the holding section, the heat about to be transferred from the heat conduction reducing section to the holding section. For example, when one or both of the surfaces of the heat-conduction reducing section and the holding section have a rough form with concaves and convexes or a form having protrusions, the air gap is formed when the heat conduction reducing section surface and the holding section are connected. Consequently, in the physical quantity detecting device, the influence of the heat from the electronic component on the physical quantity detector is further suppressed.

### Application Example 5

In the physical quantity detecting device according to the application example described above, it is preferable that the holding section and the heat-conduction reducing section are mechanically connected.

With this configuration, since the holding section and the heat-conduction reducing section are mechanically connected by, for example, screws or rivets, compared with filling an adhesive or the like between the holding section and the heat-conduction reducing section to adhere and connect both the surfaces of the holding section and the heat-conduction reducing section, transfer of the heat is less easily performed because a degree of adhesion between the holding section and the heat-conduction reducing section is low. In this case, for example, if there are gaps or the like between the holding section and the heat-conduction reducing section, transfer of the heat is much less easily performed. Consequently, the physical quantity detecting device includes a configuration for further suppressing heat transfer to the holding section via the heat-conduction reducing section, excellent in impact resistance and also excellent in disassembling properties during maintenance.

### Application Example 6

In the physical quantity detecting device according to the application example described above, it is preferable that the physical quantity detecting device further includes a circuit board including an opening section formed in a position overlapping the heat-conduction reducing section in plan view from a direction in which the holding section and the heat-conduction reducing section overlap, the electronic component being arranged on the inner side of the opening section in the plan view, and the circuit board being arranged to hold the heat-conduction reducing section between the circuit board and the holding section. It is preferable that the physical quantity detecting device includes a circuit board including an opening section, and the electronic component is arranged in the opening section in plan view. It is preferable that the circuit board and the heat-conduction reducing section are connected.

With this configuration, the holding section, the heat-conduction reducing section, and the opening section are arranged to overlap one another in order in plan view. The electronic component is arranged on the inner side of the opening section. The circuit board is arranged in a position where the heat-conduction reducing section is held between the circuit board and the holding section. In the physical quantity detecting device having such a configuration, the heat generated from the electronic component is insulated by the heat-conduction reducing section and hardly transferred in the direction of the holding section and is mainly emitted from the opening section in the opposite direction of the holding section. Consequently, in the physical quantity detecting device, the influence of the heat from the electronic component on the physical quantity detector is generally suppressed and excellent detection accuracy can be maintained. Since the electronic component is housed on the inside of the opening section, it is possible to reduce a setting space for the electronic component and attain a reduction in the size of the physical quantity detecting device.

### Application Example 7

In the physical quantity detecting device according to the application example described above, it is preferable that at least a part of the circuit board is present between the electronic component and the heat-conduction reducing section.

With this configuration, apart of the circuit board is provided between the electronic component and the heat-conduction reducing section. That is, the holding section, the heat-conduction reducing section, a part of the circuit board, and the opening section are arranged to overlap one another in order in plan view. Since a part of the circuit board is present between the opening section and the heat-conduction reducing section as well, it is possible to suppress the influence of the heat from the electronic component on the physical quantity detector. Further, since a contact area of the heat-conduction reducing section and the circuit board increases, it is possible to improve impact resistance and the like of the heat-conduction reducing section.

### Application Example 8

In the physical quantity detecting device according to the application example described above, it is preferable that the heat-conduction reducing section is a part of the circuit board.

With this configuration, since a part of the circuit board is the heat-conduction reducing section, it is unnecessary to separately arrange another heat-conduction reducing section. Consequently, in the physical quantity detecting device, it is possible to attain a reduction in the number of members in use, a reduction in assembly man-hour, and the like.

### Application Example 9

In the physical quantity detecting device according to the application example described above, it is preferable that the holding section is present between the physical quantity detector and the electronic component.

With this configuration, the physical quantity detector and the electronic component are arranged via the holding section. Therefore, the physical quantity detector is not directly affected by the heat of the electronic component.

### Application Example 10

An electronic apparatus according to this application example including the physical quantity detecting device according to the application example.

The electronic apparatus according to this application example includes the physical quantity detecting device according to the application example. In the physical quantity detecting device, the influence of heat on the physical quantity detector from the electronic component is suppressed. It is possible to maintain excellent detection accuracy. In such an electronic apparatus, improvement of characteristic and reliability of the apparatus is attained.

### Application Example 11

A moving object according to this application example including the physical quantity detecting device according to the application example.

The moving object according to this application example includes the physical quantity detecting device according to the application example. In the physical quantity detecting device, the influence of heat on the physical quantity detector from the electronic component is suppressed. It is possible to maintain excellent detection accuracy. In such a moving object, a moving state, a posture, and the like can be surely grasped by a detecting function of the physical quantity detecting device. It is possible to perform safe and stable movement.

### BRIEF DESCRIPTION OF THE DRAWINGS

The invention will be described with reference to the accompanying drawings, wherein like numbers reference like elements.

FIG. 1 is a sectional view showing the configuration of a physical quantity detecting device according to a first embodiment of the invention.

FIG. 2 is an exploded perspective view of the configuration of the physical quantity detecting device.

FIG. 3A is a plan view showing the configuration of an inclination detector.

FIG. 3B is a sectional view showing the configuration of the inclination detector.

FIG. 4A is a sectional view showing inclination detection performed when the inclination detector inclines in one direction.

FIG. 4B is a sectional view showing inclination detection performed when the inclination detector inclines in the other direction.

FIG. 5 is a sectional view showing the configuration of a physical quantity detecting device according to a second embodiment of the invention.

FIG. 6 is a sectional view showing another configuration of the physical quantity detecting device according to the second embodiment of the invention.

FIG. 7 is a sectional view showing the configuration of a physical quantity detecting device according to a third embodiment of the invention.

FIGS. 8A and 8B are sectional views showing another configuration of the physical quantity detecting device according to the third embodiment of the invention.

FIG. 9A is a perspective view showing a video camera mounted with a physical quantity detecting device.

FIG. 9B is a perspective view of a cellular phone mounted with a physical quantity detecting device.

FIG. 9C is a perspective view showing a moving object mounted with a physical quantity detecting device.

### DESCRIPTION OF EXEMPLARY EMBODIMENTS

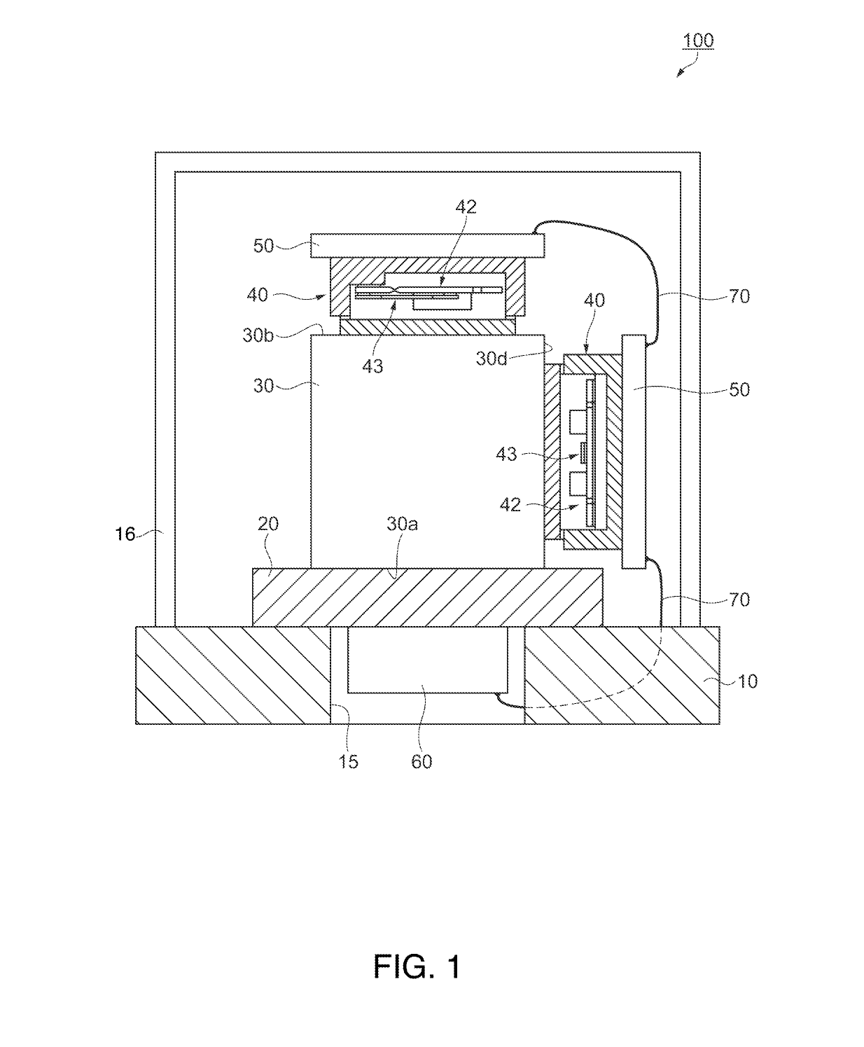

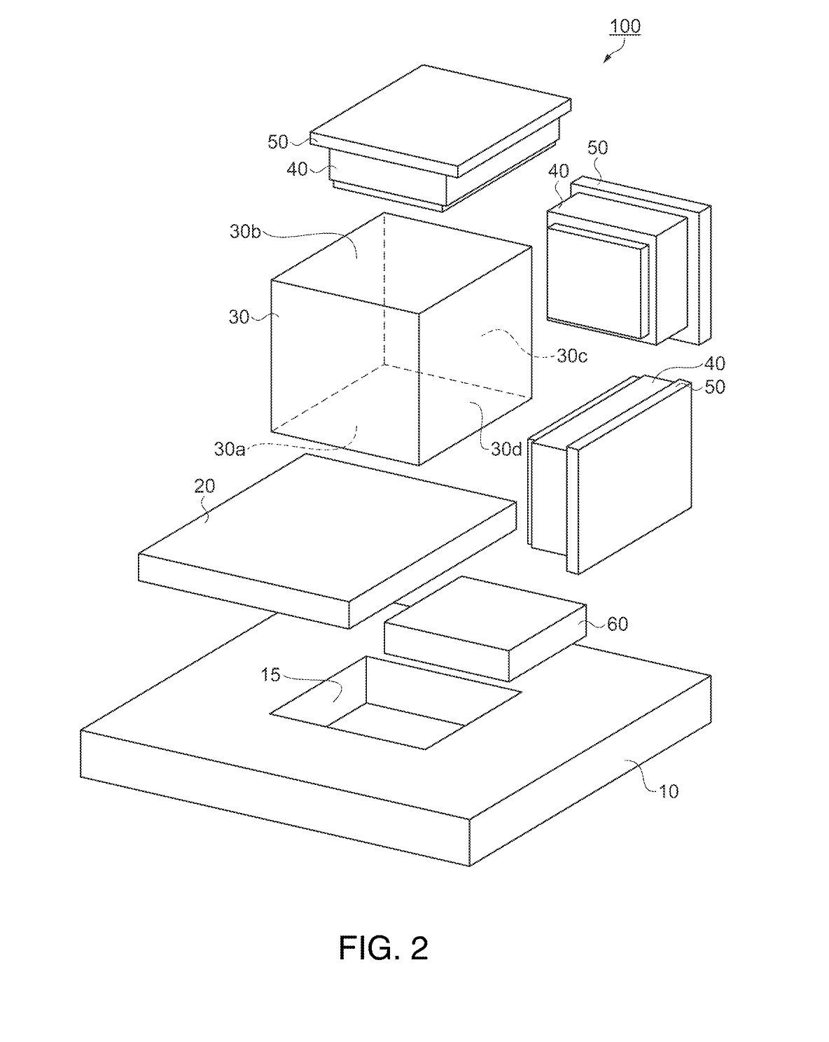

Preferred configuration examples of a physical quantity detecting device, an electronic apparatus, and a moving object according to the invention are explained below with reference to the accompanying drawings. FIG. 1 is a sectional view showing the configuration of a physical quantity detecting device according to a first embodiment of the invention. FIG. 2 is an exploded perspective view of the configuration of the physical quantity detecting device. In FIG. 2, the shapes and the arrangements of components are mainly shown. A device cover 16, wires 70, and the like are omitted.

### First Embodiment

As shown in FIGS. 1 and 2, a physical quantity detecting device 100 includes a circuit board 10 including an opening section 15, which is a square through-hole, a heat insulating material (a heat-conduction reducing section) 20 arranged on one surface side of the circuit board 10 and covering the opening section 15, a cube-shaped metal block (a holding section) 30 arranged such that a lower surface 30a thereof is fixed to the surface of the heat insulating material 20 on the opposite side of the circuit board 10, inclination detectors 40, which are physical quantity detectors, respectively arranged on an upper surface 30b opposed to the lower surface 30a of the metal block 30 and side surfaces 30c and 30d adjacent to the lower surface 30a, oscillation circuit boards 50 respectively provided in the inclination detectors 40 and for driving the inclination detectors 40, an electronic component 60 provided in the heat insulating material 20 to be housed on the inside of the opening section 15, the electronic component 60 being configured to perform control, analysis, and the like related to the inclination detectors 40 via the oscillation circuit boards 50, wires 70 connecting the oscillation circuit boards 50 and the electronic component 60, and a device cover 16 provided on the circuit board 10 and covering the heat insulating material 20, the metal block 30, the inclination detectors 40, and the oscillation circuit boards 50.

In the physical quantity detecting device 100, the circuit board 10 and the heat insulating material 20 are fixed by an adhesive. Similarly, the heat insulating material 20 and the metal block 30, the heat insulating material 20 and the electronic component 60, and the metal block 30 and the inclination detectors 40 are fixed by the adhesive. In this configuration, in plan view in the direction of the heat insulating material 20 viewed from the upper surface 30b of the metal block 30, the metal block 30, the heat insulating material 20, and the electronic component 60 are arranged to overlap one another. The opening section 15 is formed in a position overlapping the heat insulating material 20. The metal block 30 is a cube and has six surfaces (a plurality of surfaces). The inclination detectors 40 are provided on the upper surface 30b and the side surfaces 30c and 30d, which are selected surfaces among the six surfaces. Further, the heat insulating material 20 is provided on the lower surface 30a, which is a surface other than the selected surfaces (the upper surface 30b and the side surfaces 30c and 30d) of the metal block 30 on which the inclination detectors 40 are provided.

The metal block 30 is formed of aluminum (Al), which is light in weight and easily machined. The heat insulating material 20 only has to be a material that can insulate heat. In this configuration, glass epoxy resin is used as the heat insulating material 20. The heat insulating material 20 plays a role of suppressing the heat of the electronic component 60 from being transferred to the side of the metal block 30. The heat insulating material 20 functioning as the heat-conduction reducing section only has to be a material that reduces the heat of the electronic component 60 transferred to the metal block 30. Therefore, the heat insulating material 20 only has to be a material having thermal conductivity smaller than the thermal conductivity of the metal block 30. For example, when the metal block 30 is made of an aluminum alloy or a metal such as stainless steel or copper, as the material of the heat insulating material 20, acrylic glass, polyvinyl chloride (PVC), polyurethane, silicon, epoxy resin, or the like only has to be used. The electronic component 60 of the physical quantity detecting device 100 includes an IC or the like. Heat generation during driving tends to be larger in the electronic component 60 having higher performance.

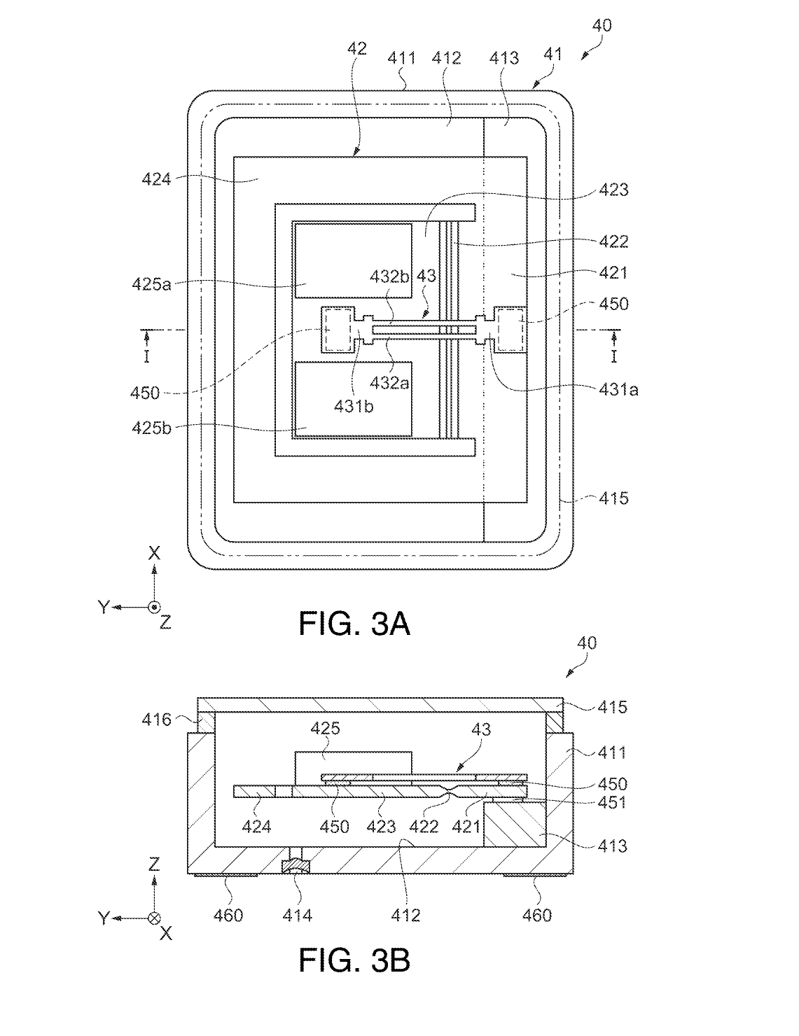

The inclination detector 40 included in the physical quantity detecting device 100 is explained. FIG. 3A is a plan view showing the configuration of the inclination detector. FIG. 3B is a sectional view showing the configuration of the inclination detector. FIG. 3B shows a cross section of the inclination detector 40 taken along line I-I in FIG. 3A. In the figures, an X axis, a Y axis, and a Z axis are shown as three axes orthogonal to one another. As shown in FIG. 3A, the inclination detector 40 includes a package 41, an element base body 42, and an inclination detecting element 43. First, the package 41 includes a package base 411 and a lid 415. The package base 411 includes a recessed section 412 formed on the inner side, a step section 413 provided along the X-axis direction at an end of the bottom surface in the recessed section 412 and for fixing the element base body 42, and a sealing section 414 provided on the bottom surface of the recessed section 412 and including a through-hole and a sealing material for closing the through-hole. External terminals 460 for connection to the oscillation circuit board 50 are formed on the outer side of the bottom surface in the recessed section 412. The package base 411 is formed of an aluminum oxide sintered body obtained by laminating and baking ceramic green sheets. However, the package base 411 can also be formed using a material such as quartz, glass, or silicon.

The lid 415 has a flat shape and arranged to cover the recessed section 412 of the package base 411. As the lid 415, a material same as the material of the package base 411, metal such as kovar or stainless steel, and the like can be used. In this configuration, kovar is used. The lid 415 is joined to the package base 411 via a seam ring 416. When the package base 411 and the lid 415 are joined, the recessed section 412 can be sealed in a decompressed hermetically sealed state. In the physical quantity detecting device 100, the lid 415 side of the inclination detector 40 is arranged to be opposed to metal block 30 (FIG. 1).

In the inclination detector 40, the sealing of the recessed section 412 is performed by a method of, after joining the package base 411 and the lid 415, releasing the air in the recessed section 412 from the through-hole of the sealing section 414 and decompressing the recessed section 412, and closing the through-hole with a brazing material (sealing material). Consequently, the element base body 42 and the inclination detecting element 43 are sealed in the recessed section 412 in the decompressed hermetically sealed state. The inside of the recessed section 412 may be filled with an inert gas such as nitrogen, helium, or argon.

The element base body 42 and the inclination detecting element 43 are explained. In this configuration, the element base body 42 and the inclination detecting element 43 are formed by etching a quartz plate. First, the element base body 42 includes a fixed section 421 extending in a tabular shape in the X-axis direction and fixed to the step section 413 by an adhesive 451, a joint section 422 provided in the Y-axis direction of the fixed section 421, a movable section 423 extending in a rectangular shape from the joint section 422 in the opposite direction of the fixed section 421, a frame section 424 extending from one end of the fixed section 421 to the other end of the fixed section 421 along the outer edge of the movable section 423, and two mass sections 425 (425a and 425b) provided on the surface of the movable section 423 opposed to the lid 415 and formed in a rectangular shape in plan view.

The movable section 423 of the element base body 42 is surrounded by the fixed section 421 and the frame section 424, connected to the fixed section 421 via the joint section 422, and in a so-called cantilevered state. The joint section 422 is formed thinner than the fixed section 421 and the movable section 423 to allow the movable section 423 to easily bend in the Z-axis direction resisting the restraint of the fixed section 421.

The inclination detecting element 43 is arranged along the Y-axis direction in the center position in the X-axis direction on the side of the surface of the element base body 42 opposed to the lid 415. The mass sections 425a and 425b are respectively symmetrically provided with respect to the inclination detecting element 43 arranged in this way. The inclination detecting element 43 includes a base section 431a fixed to the fixed section 421 of the element base body 42 by an adhesive 450, a base section 431b fixed to the movable section 423 of the element base body 42 by the adhesive 450, and vibrating beam sections 432 (432a and 432b) that perform vibration for detecting a physical quantity, between the base section 431a and the base section 431b.

Each of the vibrating beam sections 432 of the inclination detecting element 43 has a prism shape. When a driving signal (an alternating-current voltage) is applied to excitation electrodes (not shown in the figure) provided in the vibrating beam sections 432, the vibrating beam sections 432 bend and vibrate to separate from or come close to each other along the X axis. The driving signal is applied to the excitation electrodes from the external terminals 460 via not-shown internal wires or the like.

As the material of the inclination detecting element 43, besides the quartz, for example, piezoelectric materials such as lithium tantalate (LiTaO₃), lithium tetraborate (Li₂B₄O₇), lithium niobate (LiNbO₃), lead zirconate titanate (PZT), zinc oxide (ZnO), and aluminum nitride (AlN) can be used. Further, as the material of the inclination detecting element 43, non-piezoelectric materials such as silicon and germanium including a film of a piezoelectric material may be used.

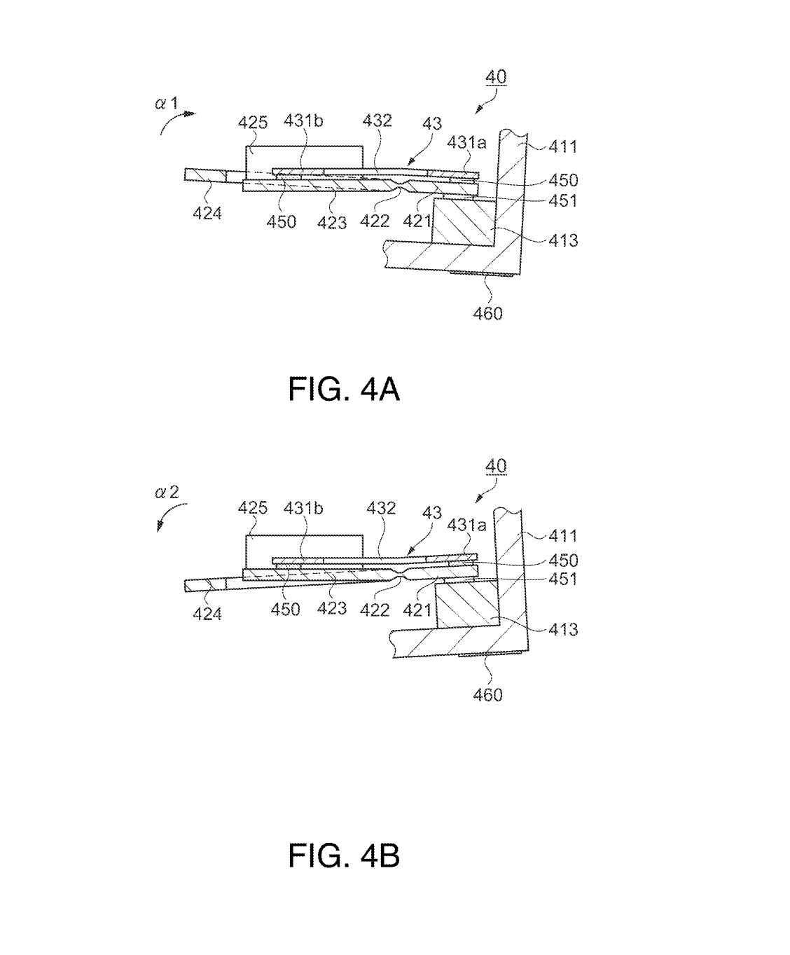

The operation of the inclination detector 40 is explained. FIG. 4A is a sectional view showing inclination detection performed when the inclination detector inclines in one direction. FIG. 4B is a sectional view showing inclination detection performed when the inclination detector inclines in the other direction. As shown in FIG. 4A, when the package base 411 of the inclination detector 40 inclines in an arrow α1 direction (a direction in which the Y axis rotates to the right in FIG. 3B), the fixed section 421 and the frame section 424 of the element base body 42 and the base section 431a of the inclination detecting element 43 incline in the same direction together with the package base 411. On the other hand, since the movable section 423 is connected to the fixed section 421 via the joint section 422, the movable section 423 maintains the original posture for awhile according to bending of the joint section 422. That is, the fixed section 421 and the movable section 423 are bent to the step section 413 side across the joint section 422. At this point, the mass sections 425a and 425b play a role of contributing to the maintenance of the original posture of the movable section 423.

Consequently, in the inclination detecting element 43, the base section 431a is bonded and fixed to the fixed section 421 and the base section 431b is bonded and fixed to the movable section 423. Therefore, forces in directions in which the base section 431a and the base section 431b move away from each other are applied to the base section 431a and the base section 431b and tensile stress occurs in the vibrating beam sections 432. Therefore, the frequency of vibration of the vibrating beam sections 432 increases.

On the other hand, as shown in FIG. 4B, when the package base 411 of the inclination detector 40 inclines in an arrow α2 direction (a direction in which the Y axis rotates to the left in FIG. 3B), the fixed section 421 and the frame section 424 of the element base body 42 and the base section 431a of the inclination detecting element 43 incline in the same direction together with the package base 411. On the other hand, since the movable section 423 is connected to the fixed section 421 via the joint section 422, the movable section 423 maintains the original posture for awhile according to bending of the joint section 422 in a direction opposite to the direction shown in FIG. 4A. That is, the fixed section 421 and the movable section 423 are bent to the opposite side of the step section 413 side across the joint section 422.

Consequently, in the inclination detecting element 43, forces in directions in which the base section 431a and the base section 431b move close to each other are applied to the base section 431a and the base section 431b and compressive stress occurs in the vibrating beam sections 432. Therefore, the frequency of vibration of the vibrating beam sections 432 decreases.

The inclination detector 40 can accurately derive a degree of inclination by detecting a frequency change of the inclination detecting element 43 as explained above. The inclination detector 40 derives the degree of inclination on the basis of a relation between a frequency change and inclination calculated in advance in association with an attachment posture of the inclination detector 40. In the physical quantity detecting device 100, the three inclination detectors 40 are respectively provided in the metal block 30 in different three postures. Therefore, since tilts in three directions of the physical quantity detecting device 100 can be simultaneously detected, it is possible to accurately detect the tilt of the physical quantity detecting device 100.

In the physical quantity detecting device 100 explained above, the metal block 30, the heat insulating material 20, and the electronic component 60 housed in the opening section 15 of the circuit board 10 are arranged to overlap one another in plan view. With such a configuration, heat generated by driving of the electronic component 60 is generally insulated by the heat insulating material 20. Consequently, the heat is emitted from the opening section 15 and is hardly transferred to the side of the metal block 30. That is, the inclination detector 40 is hardly affected by the heat from the electronic component 60. The physical quantity detecting device 100 can maintain excellent detection accuracy. In the physical quantity detecting device 100, the electronic component 60 is housed in the opening section 15 of the circuit board 10. Therefore, an increase in space due to the electronic component 60 does not occur. The physical quantity detecting device 100 can be reduced in size.

The physical quantity detecting device 100 can also be used as devices that detect acceleration and the like besides the device that detects an inclination. That is, the physical quantity detecting device 100 can also function as an acceleration detecting device by detecting, with the inclination detecting element 43, displacement of the movable section 423 due to acceleration applied thereto.

### Second Modification

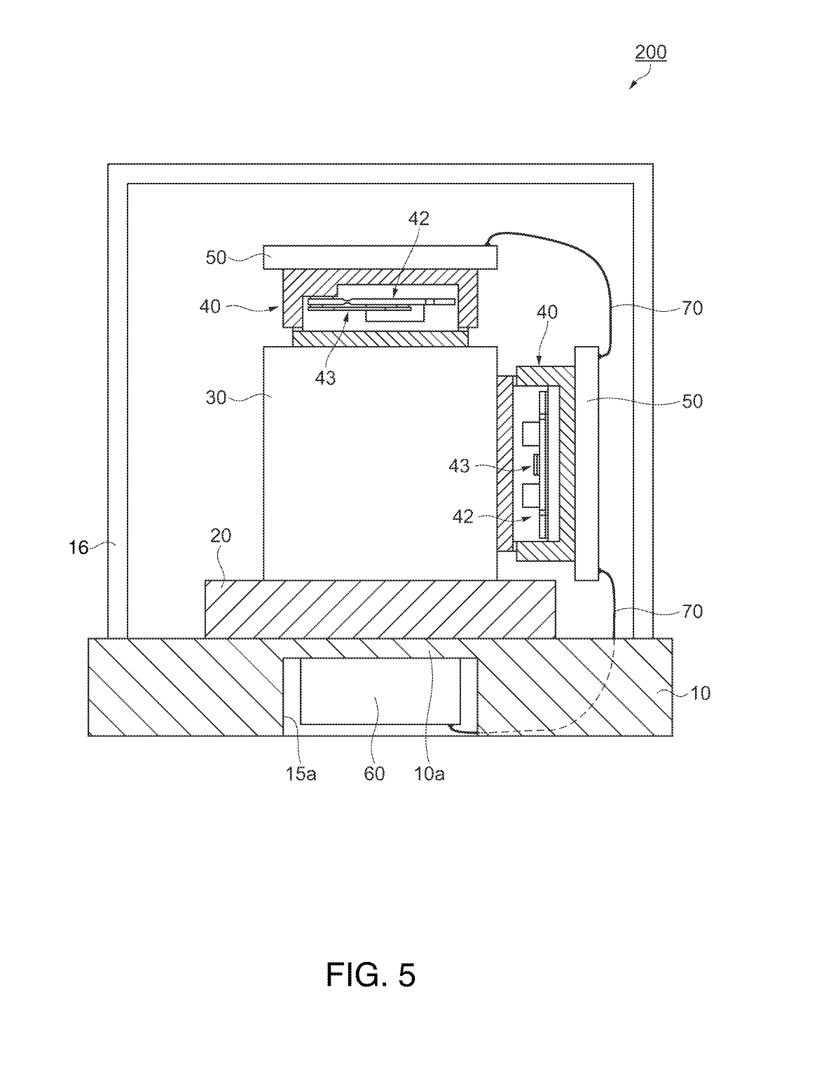

Another preferred example in the physical quantity detecting device 100 is explained. FIG. 5 is a sectional view showing the configuration of a physical quantity detecting device according to a second embodiment of the invention. A physical quantity detecting device 200 in the second embodiment is different from the physical quantity detecting device 100 in the first embodiment in the circuit board 10 and an opening section 15a. Therefore, sections other than the different sections are denoted by numerals and signs same as those in the first embodiment and explained.

As shown in FIG. 5, the physical quantity detecting device 200 includes the circuit board 10, the heat insulating material 20 arranged on one surface side of the circuit board 10, the cube-shaped metal block 30 arranged such that the lower surface 30a thereof is fixed to the surface of the heat insulating material 20 on the opposite side of the circuit board 10, the inclination detectors 40 respectively arranged on the upper surface 30b and the side surfaces 30c and 30d of the metal block 30, the oscillation circuit boards 50 respectively provided in the inclination detectors 40, and the device cover 16 provided on the circuit board 10, and covering the heat insulating material 20, the metal block 30, the inclination detectors 40, and the oscillation circuit boards 50.

The physical quantity detecting device 200 includes the opening section 15a formed in a concave shape in which an opening is formed on the surface of the circuit board 10 on the opposite side of the heat insulating material 20, an opening section substrate 10a provided between the opening section 15a and the heat insulating material 20 and forming a part of the circuit board 10, the electronic component 60 provided on the opening section substrate 10a to be housed on the inside of the opening section 15a, and the wires 70 connecting the oscillation circuit boards 50 and the electronic component 60. In this way, unlike the physical quantity detecting device 100 in the first embodiment, the electronic component 60 is not provided in the heat insulating material 20 but is provided in the opening section substrate 10a, which is a part of the circuit board 10. That is, in the physical quantity detecting device 200, the circuit board 10 (the opening section substrate 10a) is held between the electronic component 60 and the heat insulating material 20.

In the physical quantity detecting device 200 explained above, the opening section substrate 10a, which is a part of the circuit board 10, is provided on the side of the heat insulating material 20 in the concave opening section 15a formed on the circuit board 10. That is, the electronic component 60 is set on the opening section substrate 10a to be housed on the inner side of the opening section 15a. Consequently, the heat insulating material 20 of the physical quantity detecting device 200 insulates heat transfer. A contact area of the heat insulating material 20 with the circuit board 10 (the opening section substrate 10a) increases compared with the physical quantity detecting device 100 in the first embodiment. Therefore, shock resistance and the like are improved and the metal block 30 can be firmly supported.

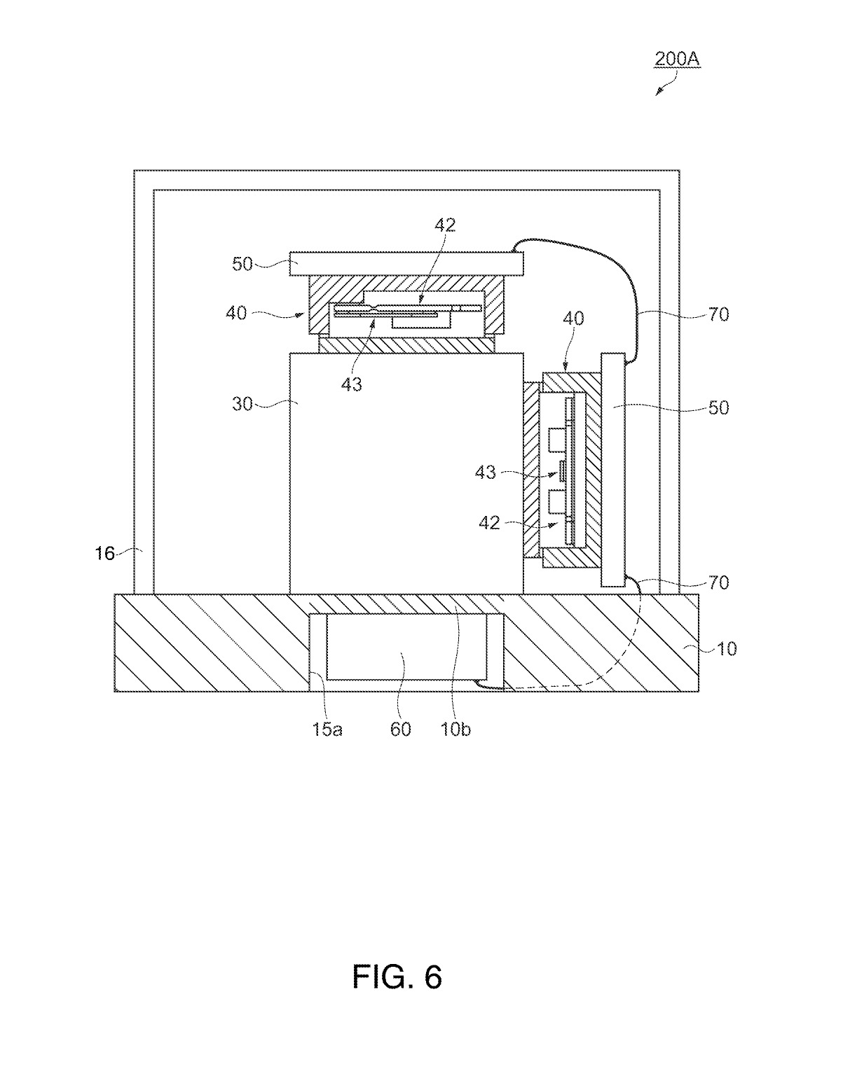

FIG. 6 is a sectional view showing another configuration of the physical quantity detecting device according to the second embodiment of the invention. A physical quantity detecting device 200A shown in FIG. 6 is different from the physical quantity detecting device 200 in a form of a heat insulating material. As shown in FIG. 6, in the physical quantity detecting device 200A, the metal block 30 is directly fixed to the circuit board 10. A section of the circuit board 10 located between the electronic component 60 and the metal block 30 is a heat insulating section 10b having heat insulation properties. The heat insulating section 10b is a section forming a part of the circuit board 10 and corresponding to the opening section substrate 10a in the physical quantity detecting device 200. That is, in plan view, the metal block 30, the heat insulating section 10b of the circuit board 10, the opening section 15a, and the electronic component 60 are arranged to overlap one another in order.

In the physical quantity detecting device 200A, the heat insulating material 20 included in the physical quantity detecting device 200 is unnecessary. Therefore, it is possible to further reduce the size of the physical quantity detecting device 200A than the physical quantity detecting device 200 and suppress the influence of heat from the electronic component 60 on the inclination detector 40. Note that, in terms of a heat insulation effect, the configuration in which the heat insulating material 20 is provided between the circuit board 10 and the metal block 30 as in the physical quantity detecting device 200 is superior to the configuration in which a part of the circuit board 10 is the heat insulating section 10b as in the physical quantity detecting device 200A.

### Third Embodiment

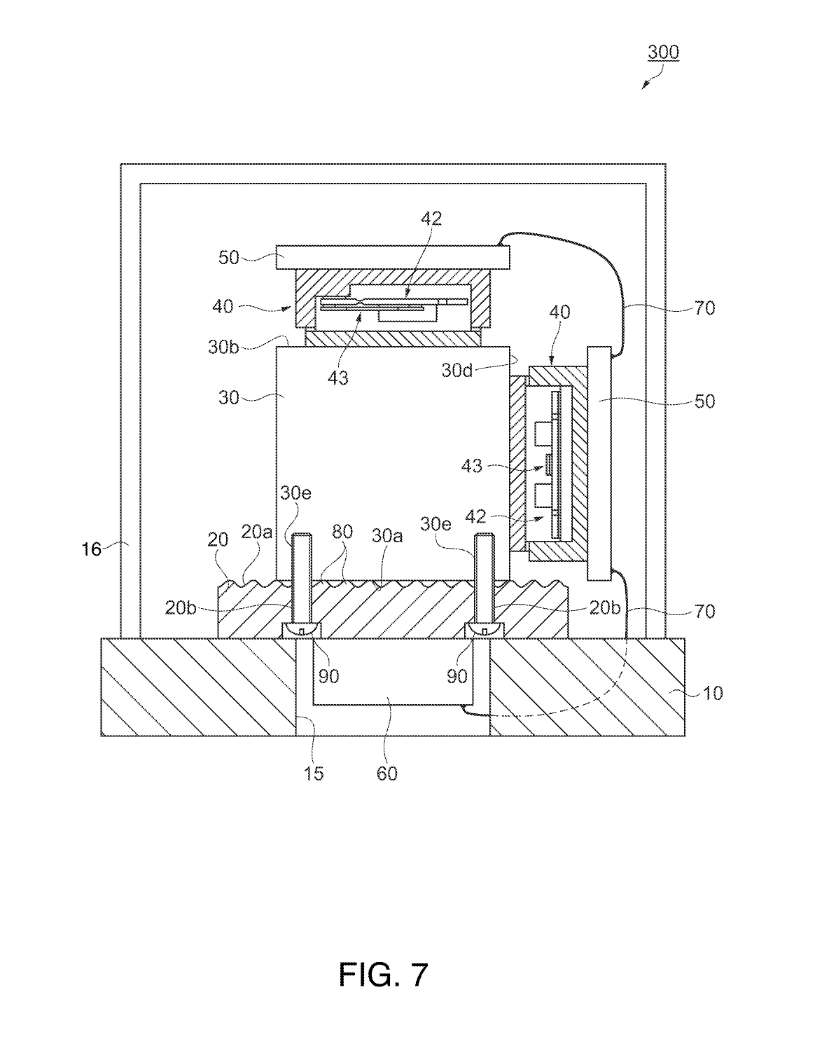

Another preferred example in the physical quantity detecting device 100 is explained. FIG. 7 is a sectional view showing the configuration of a physical quantity detecting device according to a third embodiment of the invention. A physical quantity detecting device 300 in the third embodiment has characteristics in setting of respective surfaces on which the metal block 30 and the heat insulating material 20 and the inclination detectors 40 are connected and a connection structure of the heat insulating material 20 and the metal block 30. The characteristic sections are different from the characteristic sections of the physical quantity detecting device 100 in the first embodiment. Therefore, sections other than the sections different from those in the first embodiment are denoted by the same reference numerals and signs and explanation of the sections is omitted.

As shown in FIG. 7, the physical quantity detecting device 300 includes the circuit board 10 including the opening section 15, which is the square through-hole, the heat insulating material 20 arranged on one surface side of the circuit board 10, the cube-shaped metal block 30 arranged such that the lower surface 30a thereof is fixed to the surface of the heat insulating material 20 on the opposite side of the circuit board 10, the inclination detectors 40 respectively arranged on the upper surface 30b and the side surfaces 30c and 30d of the metal block 30, the oscillation circuit boards 50 respectively provided in the inclination detectors 40, the electronic component 60 provided in the heat insulating material 20 to be housed on the inside of the opening section 15, the wires 70 connecting the oscillation circuit boards 50 and the electronic component 60, and the device cover 16 provided on the circuit board 10, and covering the heat insulating material 20, the metal block 30, the inclination detectors 40, and the oscillation circuit boards 50.

The setting of the respective surfaces on which the metal block 30 and the heat insulating material 20 and the inclination detectors 40 are connected is explained. First, a connection surface 20a of the heat insulating material 20 connected to the lower surface 30a of the metal block 30 is formed roughly in a concave-convex shape on the surface. Concave portions between the connection surface 20a and the lower surface 30a are air gaps 80 including the air. In FIG. 7, concaves and convexes of the connection surface 20a are exaggeratingly shown to be clearly seen. If the air gaps 80 are present between the connection surface 20a of the heat insulating material 20 and the lower surface 30a of the metal block 30 in this way, it is possible to more effectively suppress transfer of heat between both the surfaces compared with transfer of heat that occurs when the connection surface 20a and the lower surface 30a adhere to each other. Further, it has been known that the surface roughness Ra of the connection surface 20a is equal to or larger than 0.5 μm. As aground for the knowledge, there is an experiment result shown in Table 1 below.

TABLE 1

Surface roughness (μm)

| | 0.1 | 0.3 | 0.5 | 0.7 |
|---|---|---|---|---|
| Evaluation | C | C | B | A |

As shown in Table 1, the surface roughness Ra of the connection surface 20a in the heat insulating material 20 was set to 0.1 μm, 0.3 μm, 0.5 μm, and 0.7 μm and the air gaps 80 were formed between the connection surface 20a and the lower surface 30a. An effect of suppressing heat transfer from the heat insulating material 20 to the metal block 30 was evaluated. As a result, when the surface roughness Ra of the connection surface 20a was 0.1 μm and 0.3 μm, there was almost no effect of suppressing heat transfer. On the other hand, it was found that, if the surface roughness Ra of the connection surface 20a was 0.5 μm, there was the effect of suppressing heat transfer and, if the surface roughness Ra of the connection surface 20a was 0.7 μm, there was a more suppression effect. That is, if the surface roughness Ra of the connection surface 20a is set to be equal to or larger than 0.5 μm, it is possible to effectively suppress the heat transfer from the heat insulating material 20 to the metal block 30. As measurement conditions for the “surface roughness Ra”, Ra was “arithmetic average roughness” and a cutoff value λc was set to 0.25 mm and a probe tip radius r was set to 2 μm on the basis of JIS-B-0601-2001.

For the connection of the connection surface 20a of the heat insulating material 20 and the lower surface 30a of the metal block 30, an adhesive may be used as in the first and second embodiments. However, when the adhesive is used, in some case, the air gaps 80 are filled with the adhesive and an air gap capacity decreases and the suppression effect for heat transfer is lightly reduced. Therefore, in the physical quantity detecting device 300, the heat insulating material 20 and the metal block 30 are mechanically connected by screws 90. Therefore, in the heat insulating material 20, screw holes 20b through which the screws 90 are inserted are provided. In the metal block 30, screw holes 30e in which the screws 90 are fixed are provided. Since the heat insulating material 20 and the metal block 30 are connected by the screws 90 in this way, it is possible to surely secure the air gaps 80 between the connection surface 20a and the lower surface 30a.

The physical quantity detecting device 300 explained above has the configuration in which the surface roughness Ra of the connection surface 20a of the heat insulating material 20 to which the metal block 30 is connected is set to be equal to or larger than 0.5 μm and the air gaps 80 are provided between the connection surface 20a and the lower surface 30a of the metal block 30, whereby the air gaps 80 including the air layer having high heat insulation properties effectively insulate the heat about to be transferred from the heat insulating material 20 to the metal block 30. Further, in the physical property detecting device 300, since the heat insulating material 20 and the metal block 30 are mechanically connected by the screws 90, it is possible to surely form the air gaps 80 between the heat insulating material 20 and the metal block 30. Consequently, the physical quantity detecting device 300 can further suppress the influence of heat on the inclination detectors 40 from the electronic component 60.

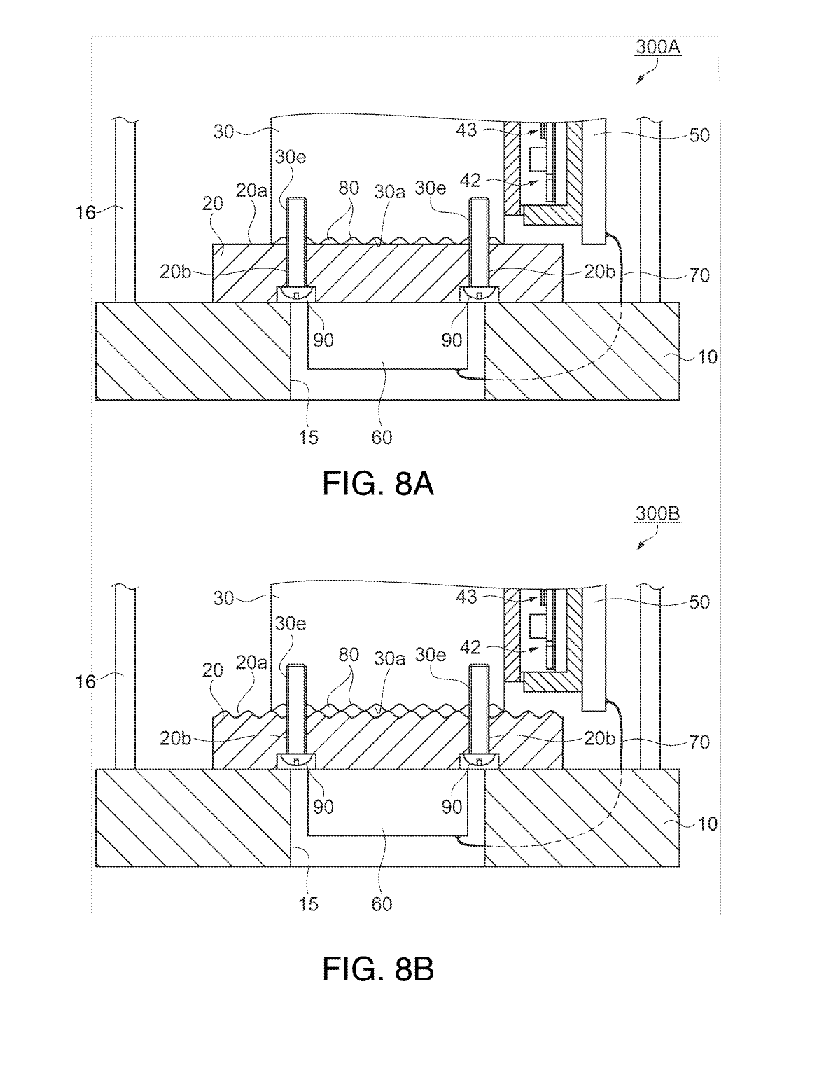

FIGS. 8A and 8B are sectional views showing another configuration of the physical quantity detecting device according to the third embodiment of the invention. First, as shown in FIG. 8A, a physical quantity detecting device 300A is different in a formation form of the air gaps 80 formed by the lower surface 30a of the metal block 30 and the connection surface 20a of the heat insulating material 20. That is, in the physical quantity detecting device 300A, the lower surface 30a of the metal block 30 is formed roughly in a concave-convex shape. Concave portions between the connection surface 20a of the heat insulating material 20 and the lower surface 30a are the air gaps 80 including the air. The physical quantity detecting device 300A having such a configuration has performance equivalent to the performance of the physical quantity detecting device 300 in heat insulation properties between the heat insulating material 20 and the metal block 30.

FIG. 8B is a sectional view showing another configuration of the physical quantity detecting device according to the third embodiment of the invention. As shown in FIG. 8B, both of the lower surface 30a of the metal block 30 and the connection surface 20a of the heat insulating material 20 are formed roughly in a concave-convex shape. Concave portions between the lower surface 30a and the connection surface 20a are the air gaps 80 including the air. In the physical quantity detecting device 300B having such a configuration, the air gaps 80 can be formed larger than the air gaps 80 in the physical quantity detecting devices 300 and 300A, and therefore the physical quantity detecting device 300B has an excellent performance as compared with the physical quantity detecting devices 300 and 300A in terms of heat insulation properties between the heat insulating material 20 and the metal block 30.

### Electronic Apparatus

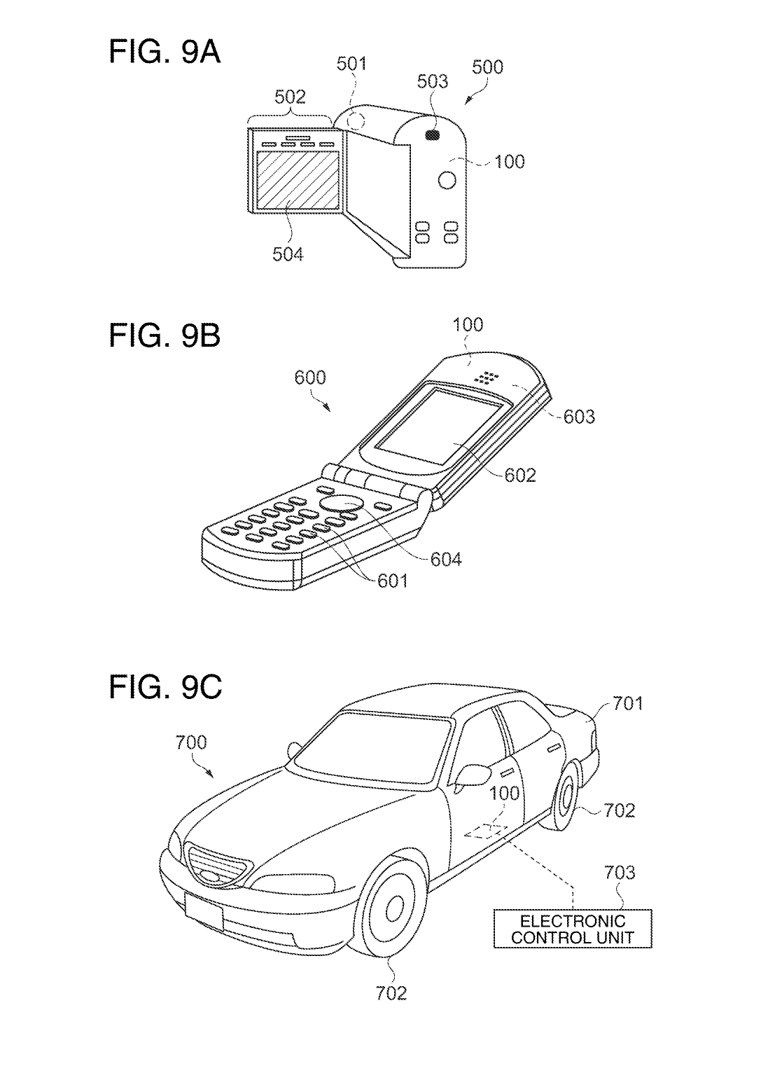

An electronic apparatus including any one of the physical quantity detecting devices 100, 200, 200A, 300, 300A, and 300B is explained. FIG. 9A is a perspective view showing a video camera including the physical quantity detecting device. FIG. 9B is a perspective view showing a cellular phone including the physical quantity detecting device. A video camera 500 and a cellular phone 600 functioning as the electronic apparatus are mounted with the physical quantity detecting device 100 among the physical quantity detecting devices 100, 200, 200A, 300, 300A, and 300B according to the embodiments of the invention. First, the video camera 500 shown in FIG. 9A includes an image receiving section 501, an operation section 502, a sound input section 503, and a display unit 504. The video camera 500 includes the physical quantity detecting device 100. Since the three inclination detectors 40 detect inclinations in the X-axis, Y-axis, and Z-axis directions, the video camera 500 can exhibit a function of correcting a camera shake. Consequently, the video camera 500 can record a clear moving image video.

The cellular phone 600 shown in FIG. 9B includes a plurality of operation buttons 601, a display section 602, a camera mechanism 603, and a shutter button 604 and functions as a telephone and a camera. The cellular phone 600 includes the physical quantity detecting device 100. Since the three inclination detectors 40 detect inclinations in the X-axis, Y-axis, and Z-axis directions, the cellular phone 600 can exhibit a function of correcting a camera shake of the camera mechanism 603. Consequently, the cellular phone 600 can record a clear image with the camera mechanism 603.

### Moving Object

A moving object including any one of the physical quantity detecting devices 100, 200, 200A, 300, 300A, and 300B is explained. FIG. 9C is a perspective view showing a moving object including a physical quantity detecting device. As shown in FIG. 9C, a moving object 700 in this case is an automobile. As an example, the physical quantity detecting device 100 is used in the moving object 700. In the moving object 700, the physical quantity detecting device 100 is incorporated in an electronic control unit (ECU: electronic control section) 703 mounted on a vehicle body 701. Since the three inclination detectors 40 of the physical quantity detecting device 100 detect the inclinations of the vehicle body 701, the electronic control unit 703 can grasp the posture, the moving state, and the like of the moving object 700 and accurately perform the control of tires 702 and the like. Consequently, the moving object 700 can perform safe and stable movement.

The physical quantity detecting device, the electronic apparatus, and the moving object explained above are not limited to the forms in the embodiments. Effects same as the effects in the embodiments can be obtained in forms such as modifications explained below.

### Modification 1

In the physical quantity detecting devices 100 and 200, the heat insulating material 20 and the metal block 30 are connected by the adhesive. However, as in the physical quantity detecting device 300, the heat insulating material 20 and the metal block 30 may be mechanically connected by the screws 90. Further, when the heat insulating material 20 and the metal block 30 are mechanically connected, in physical quantity detecting devices 100, 200, 300, 300A, and 300B, other than the screws 90, bolts and nuts, rivets, or the like may be used.

### Modification 2

In the physical quantity detecting devices 100, 200, 200A, 300, 300A, and 300B, the inclination detectors 40 are connected to the metal block 30 on the side of the lid 415. However, the inclination detectors 40 may be connected to the metal block 30 on the side of the package base 411. In the physical quantity detecting devices 100, 200, and 300, the three inclination detectors 40 are provided in the metal block to make it possible to simultaneously detect the inclinations in the three directions. However, according to a use, the inclination detectors 40 may be provided in the metal block 30 in a number other than three to detect the inclination (s) in, for example, one direction or two directions. The metal block 30 may be a polyhedron or the like other than the cube.

### Modification 3

In the physical quantity detecting devices 100, 200, 200A, 300, 300A, and 300B, it is preferable that, among the six surfaces of the metal block 30, the lower surface 30a connected to the heat insulating material 20 and the upper surface 30b and the side surfaces 30c and 30d connected to the inclination detectors 40 are in a relation of the lower surface 30a>the upper surface 30b=the side surfaces 30c and 30d in terms of the surface roughness Ra and the lower surface 30a is the roughest. Consequently, in the metal block 30, on the lower surface 30a having the large surface roughness Ra, it is possible to further insulate the heat transfer from the heat insulating material 20. On the upper surface 30b and the side surfaces 30c and 30d connected to the inclination detectors 40, it is possible to stably place the inclination detectors 40 in predetermined postures by reducing the surface roughness Ra.

### Modification 4

The inclination detecting element 43 of the inclination detector 40 may have a configuration in which the vibrating beam sections 432 include beams in a number other than two. The element base body 42 may have, for example, a configuration without the mass sections 425 or a configuration in which the mass sections 425 are arranged on both surfaces of the movable section 423. The inclination detecting element may be a detecting element having a form like the acceleration detecting element described in Patent Literature 1.

The entire disclosure of Japanese Patent Application No. 2012-245101, filed Nov. 7, 2012 is expressly incorporated by reference herein.

What is claimed is:

1. A physical quantity detecting device comprising:
a physical quantity detector;
a holding section holding the physical quantity detector;
an electronic component electrically connected to the physical quantity detector; and
a heat-conduction reducing section arranged between the holding section and the electronic component and having thermal conductivity smaller than thermal conductivity of the holding section.

2. The physical quantity detecting device according to claim 1, wherein
the holding section includes a plurality of surfaces, the heat-conduction reducing section being connected to at least one of the plurality of surfaces, and
the physical quantity detecting device includes, on a connection surface of the holding section and the heat-conduction reducing section, a portion where the holding section and the heat-conduction reducing section are connected to each other and an air gap portion where the holding section and the heat-conduction reducing section are not connected to each other.

3. The physical quantity detecting device according to claim 1, wherein
the holding section includes a plurality of surfaces, the heat-conduction reducing section being connected to at least one of the plurality of surfaces, and
in the holding section, surface roughness of a surface on which the heat-conduction reducing section is arranged is larger than surface roughness of a surface on which the physical quantity detector is arranged.

4. The physical quantity detecting device according to claim 1, further comprising a circuit board including an opening section, wherein
the electronic component is arranged in the opening section in plan view.

5. The physical quantity detecting device according to claim 4, wherein the circuit board and the heat-conduction reducing section are connected.

6. The physical quantity detecting device according to claim 4, wherein the heat-conduction reducing section is apart of the circuit board.

7. An electronic apparatus including the physical quantity detecting device according to claim 1.

8. A moving object including the physical quantity detecting device according to claim 1.
